(19) United States
(12) Patent Application Publication
(10) Pub. No.: US 2020/0248882 A1
(43) Pub. Date: Aug. 6, 2020

(54) ILLUMINATING DEVICE FOR A VEHICLE, SPECIFICALLY HIGH-RESOLUTION HEADLAMPS

(71) Applicant: Hella GmbH & Co. KGaA, Lippstadt (DE)

(72) Inventor: Bernd Fischer, Altenbeken (DE)

(21) Appl. No.: 16/750,891

(22) Filed: Jan. 23, 2020

(30) Foreign Application Priority Data
Jan. 31, 2019 (DE) 102019102475.7

(51) Int. Cl. F21S 41/143; F21S 41/153; F21S 41/255

(52) U.S. Cl. CPC F21S 41/143; F21S 41/255; F21S 41/153

(57) ABSTRACT

An illuminating device for a vehicle is provided. High resolution headlamps comprise an imaging component with an active surface on which matrix-like imaging elements are arranged for the targeted generation of pixels of a light distribution. The expansion of the active surface is bigger in a first orientation than in a second orientation vertical to the first orientation, and a projection lens from which the light emitted by the active surface during operation of the illuminating device into the area outside the vehicle. The active surface is aligned in such a way that in relation to the light distribution generated outside the vehicle pixels arranged alongside each other in a vertical orientation are generated by imaging elements that are arranged alongside each other on the active surface in the first orientation.

### CROSS REFERENCE

This application claims priority to German Application No. 10 2019 102475.7, filed Jan. 31, 2019, the entirety which is hereby incorporated by reference.

### FIELD OF THE INVENTION

The present invention relates to an illuminating device for a vehicle.

### BACKGROUND

An illuminating device of the aforementioned kind is known from DE 10 2013 215 359 B3. The illuminating device described in the same comprises an imaging component with an active surface on which light emitting diodes (LEDs) are arranged in a matrix-like shape for the targeted generation of pixels of a light distribution. In this context, the expansion of the active surface in a horizontal orientation is bigger than in a vertical orientation. The illuminating device further comprises a projection lens from which the light emitted from the active surface during operation of the illuminating device is projected into the area outside the vehicle.

Imaging pixels being projected onto the road in the case of high resolution headlamps unavoidably results in a distortion of the pixels on the road surface on account of the slanting projection plane. Whereas virtually square pixels are projected at close range, clearly distorted trapezoidal pixels are formed in the distance. This gives rise to a significant reduction in the resolution in a vertical direction as the distance increases so that any symbols being projected are distorted. Correspondingly, all pixels have the same expansion in a horizontal orientation.

### SUMMARY OF THE INVENTION

The issue underlying the present invention is the creation of an illuminating device of the type described at the beginning of this document in which the resolution in the light distribution generated by the illuminating device is improved in a vertical orientation.

In accordance with the invention, this is achieved by an illuminating device of the type described at the beginning of this document with the characteristic features of claim 1. The subclaims related to preferred embodiments of the invention.

In accordance with claim 1, it is intended that the active surface is aligned in such a way that with regard to the light distribution generated in the area outside the vehicle pixels arranged alongside each other in a vertical orientation are generated by imaging elements that are arranged alongside each other in the first orientation on the active surface. In this context, the active surface in the state installed in the vehicle can in particular be aligned in such a way that the first orientation is vertical. This means that in contrast to the current state of technology the larger expansion of the active surface can be assigned to the vertical expansion of the headlamp light distribution or the smaller expansion of the active surface can be assigned to the horizontal expansion of the headlamp light distribution. This brings about an increase in the pixel density and thus of the resolution in a vertical orientation so that the pixels can be displayed more as squares over a larger area. This makes it possible to depict symbols on the road surface at a higher resolution and in more detail.

One potential option is for the imaging elements on the active surface to take the form of light emitting diodes or as laser diodes, specifically where the imaging component is a solid state LED array. An alternative option is for the imaging component to take the form of a digital micromirror device or an LCoS or LC display or the imaging component to comprise a digital micromirror device or an LCoS or or LC display.

There is a possibility for the projection lens to feature a surface with a toric shape. In this respect, the surface with a toric shape can widen light emitted by it in one orientation corresponding to the light distribution outside the vehicle to a greater extent than light in one orientation corresponding to the vertical orientation of the light distribution outside the vehicle. This makes it possible for a surface with a toric shape to generate a light distribution with, for example, roughly the same expansion in a horizontal orientation and vertical orientation despite a larger number of pixels in the vertical orientation.

One potential option is for the surface with a toric shape to be a refractive surface. In particular, the surface with a toric shape may be the exit surface of the projection lens.

There is the option that the protection lens comprises a first portion and a second portion, where during operation of the illuminating device the light emitted by the active surface first passes through the first portion or is reflected at the first portion and subsequently passes through the second portion or is reflected at the second portion. Dividing the projection lens into two different portions makes it possible to allocate different tasks to different lens groups.

One option is that the projection lens comprises a portion which forms the active surface of the imaging component in the aspect ratio of the active surface, specifically where this portion is the first portion.

A further option is that the projection lens comprises a portion that features anamorphic properties, especially where this portion is the second portion. In this respect, the portion with anamorphic properties can widen light emitted by it in one orientation corresponding to the light distribution outside the vehicle to a greater extent than light in one orientation corresponding to the vertical orientation of the light distribution outside the vehicle. This also ensure that the light distribution that features roughly the same expansions in a horizontal orientation and vertical orientation despite a larger number of pixels in the vertical orientation.

There is the option that the expansion of the active surface in the first orientation is more than twice as big, specifically more than three times as big, for example around four times as big as the expansion in the second orientation. This corresponds in particular to typical expansion ratios of commercially available imaging components.

### BRIEF DESCRIPTION OF THE DRAWINGS

Reference is now made more particularly to the drawings, which illustrate the best presently known mode of carrying out the invention and wherein similar reference characters indicate the same parts throughout the views.

FIG. 1 is a detailed perspective of a first embodiment of an inventive illuminating device.

FIG. 2 is a side view of a detail of a second embodiment of an inventive illuminating device.

FIG. 3 is a vertical cross-section of an exemplary light distribution that was generated with an embodiment of an inventive illuminating device.

FIG. 4 is a diagram to illustrate a first exemplary pixel density.

FIG. 5 is a top view of a light distribution with the first pixel density.

FIG. 6 is a diagram to illustrate a second exemplary pixel density.

FIG. 7 is a top view of a light distribution with the second pixel density.

FIG. 8 is an exemplary depiction of an illustration of three points of an active surface of an illuminating device without targeted widening in a horizontal orientation.

FIG. 9 is an exemplary depiction of an illustration of three points of an active surface of an illuminating device with targeted widening in a horizontal orientation.

### DETAILED DESCRIPTION OF THE DRAWINGS

In the figures, identical and functionally identical parts have the same reference signs.

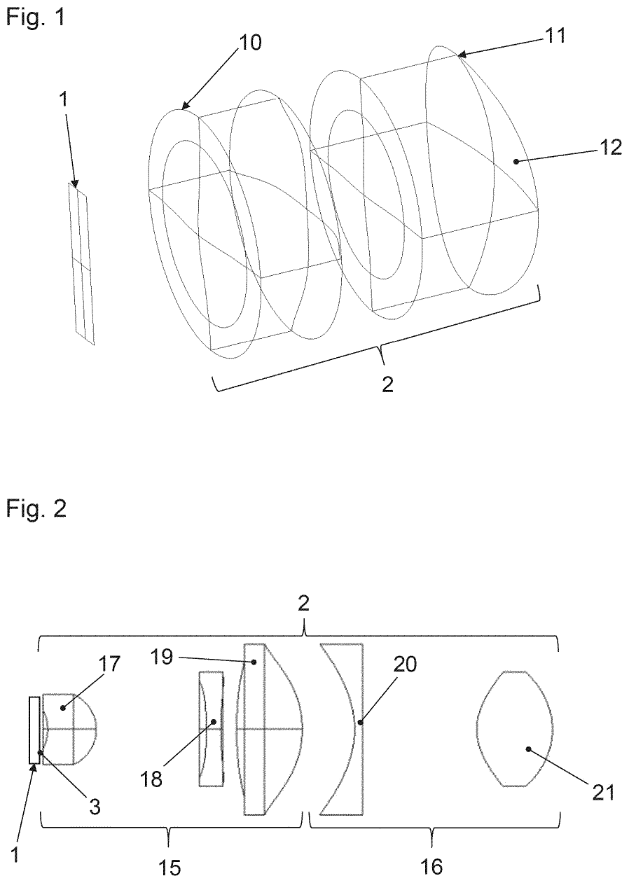

The example embodiment depicted in FIG. 1 of an inventive illuminating device takes the form of a high resolution headlamp and comprises an imaging component 1 and a projection lens 2. The imaging component 1 features an active surface 3 with imaging elements arranged in a matrix-like shape that serve the targeted generation of pixels of a light distribution.

In this context, the expansions of the active surface 3 in a first orientation that corresponds to the vertical orientation in FIG. 1 and FIG. 2 is larger than a second orientation vertical to the same that corresponds to the horizontal orientation in FIG. 1 and FIG. 2. For example, 320 imaging elements can be arranged alongside each other in the first orientation and 80 imaging elements in the second orientation.

One potential option is for the imaging elements on the active surface 3 to take the form of light emitting diodes (LEDs) or as laser diodes. Specifically, the imaging component 1 may be a solid state LED array. The light emitted by individual light emitting diodes can then be projected by the projection lens 2 into the area outside the vehicle, where the vertical orientation of the generated light distribution corresponds to the first orientation in which the active surface 3 features a greater expansion and in which more imaging elements are arranged alongside each other.

An alternative option is for the imaging component 1 to take the form of a digital micromirror device (DMD) or an LCoS or LC display or the imaging component 1 to comprise a digital micromirror device or an LCoS or or LC display. In the case of a digital micromirror device, for example, the individual mirror elements serve as imaging elements.

With this alternative design of the imaging component 1 as a digital micromirror device or as an LCoS or an LC display, the illuminating device additionally comprises at least one light source not depicted, the light from which hits the imaging component and is selectively reflected by the same or allowed to pass through in order to generate a corresponding light distribution.

Also in this design of the imaging component 1, the light emitted from the individual imaging elements is projected from the projection lens 2 into the area outside the vehicle. Here again, the vertical orientation of the generated light distribution corresponds to the first orientation in which the active surface 3 features a greater expansion and in which more imaging elements are arranged alongside each other.

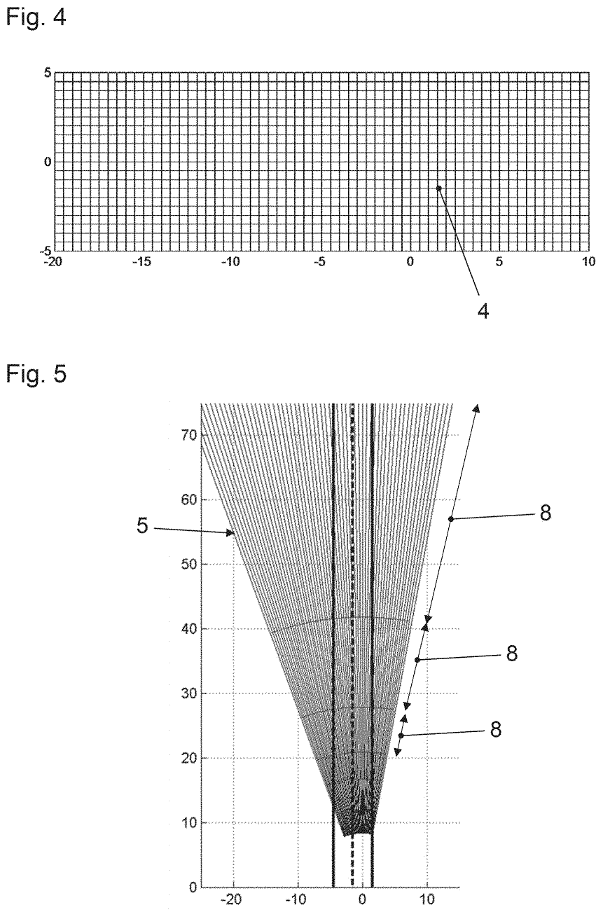

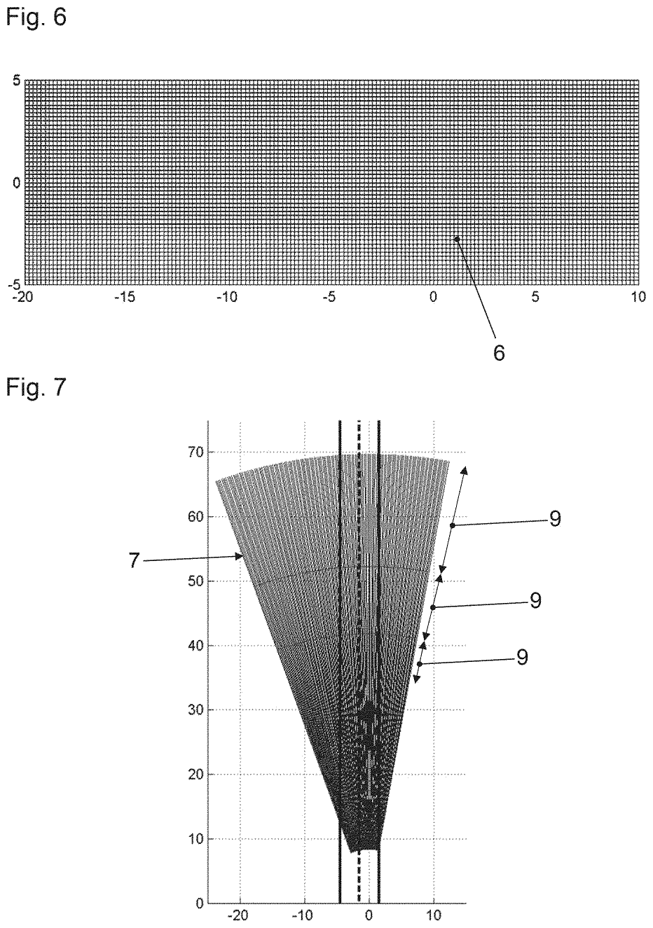

An alignment of the active surface 3 in such a way that more imaging elements are arranged in the vertical orientation than in the horizontal orientation makes is possible to depict symbols on the road surface in higher resolution and in more detail. The reason for this is that the unavoidable distortion of the pixels or segments on the road surface caused by the slanting projection plane depends on the pixel density of the light distribution in a vertical orientation. This is illustrated firstly by a comparison between FIG. 4 and FIG. 5 and secondly between FIG. 6 and FIG. 7.

FIG. 4 and FIG. 5 show schematically a first pixel density 4 and a first light distribution 5, whereas FIG. 6 and FIG. 7 illustrate a second pixel density 6 and a second light density 7. In this context, the first pixel density 4 is lower than the second pixel density 6. With the lower first pixel density 4, it is shown that segments 8 of the light distribution 5 at a further distance from the vehicle are stretched to a relatively great extent. In contrast, with the second largest pixel density 6 the segments 9 of the light distribution 7 are stretched to a lesser extent. This results in a situation where, with a higher pixel density 6 in a vertical orientation of the light distribution 7, there is less stretching or distortion and the depiction of symbols on the road surface is in a higher resolution and in more detail.

The projection lens 2 of the first embodiment of the illuminating device depicted in FIG. 1 comprises two transparent substrates 10, 11 through which the light emitted by the active surface 3 passes through one after the other. At least some of the entry and/or exit surfaces of the substrates 10, 11 are curved or formed as lenses in order to reproduce the active surface 3 in a suitable way in the area outside the vehicle. In this context, the exit surface 12 of the second substrate 11 has a toric shape.

There is certainly the option that another one of the surfaces of the substrates 10, 11 or several of the surfaces of the substrates 10, 11 have a toric shape instead of the exit surface 12 of the second substrate 11.

There is a further option of using one or more mirrors with suitably formed reflective surfaces instead of the substrates 10, 11 or instead of both substrates 10, 11.

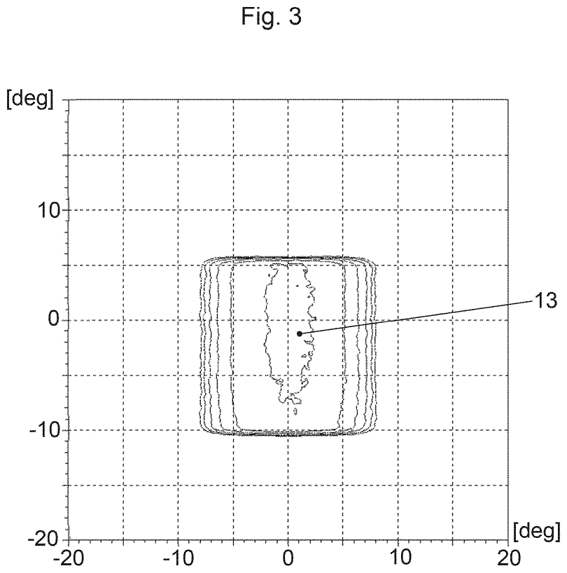

The toric design allows the exit surface 12 to widen light emitted by it in the horizontal orientation of the light distribution to a greater extent than in the vertical direction. This makes it possible to generate a light distribution in which the ratio of vertical orientation to horizontal orientation is 1:1 despite a ratio of, for example 4:1 of the vertical orientation to the horizontal orientation of the active surface 3. A vertical cross-section through an example of such a light distribution 13 is shown in FIG. 3.

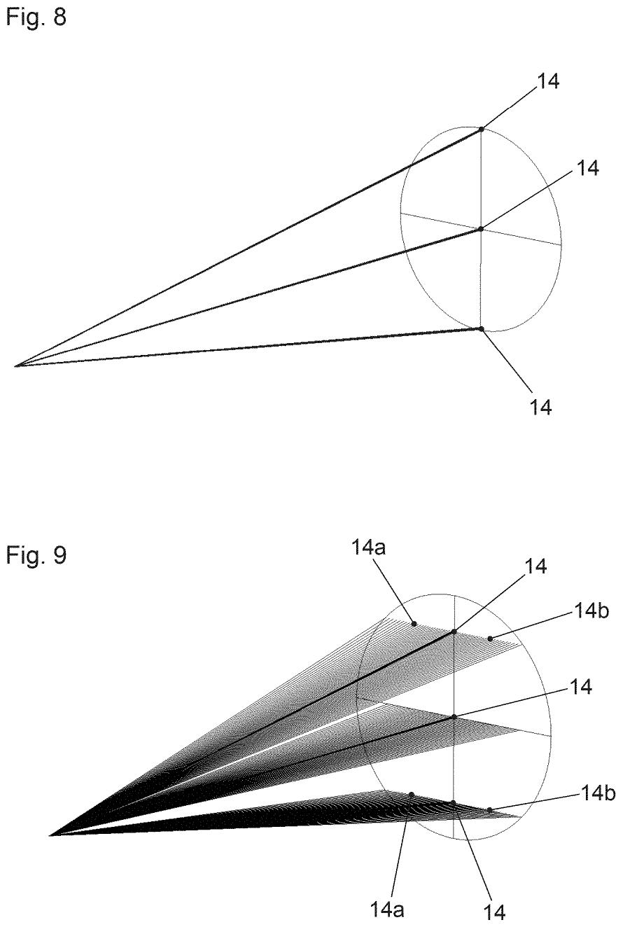

FIG. 8 and FIG. 9 illustrate the effect of the surface with a toric shape of projection lens 2. In this context, FIG. 8 shows an exemplary depiction of an illustration of three points 14 of an active surface of an illuminating device without targeted widening in a horizontal orientation. In contrast, FIG. 9 shows an exemplary depiction of an illustration of the three points 14 of an active surface of an illuminating device with targeted widening 14a, 14b in a horizontal orientation. The widening 14a, 14b can be achieved in this context by the surface with a toric shape of the projection lens 2.

The projection lens 2 of the second embodiment of the illuminating device depicted in FIG. 2 comprises a first portion 15 and a second portion 16 through which the light emitted by the active surface 3 passes though one after the other. In this respect, the first portion 15 comprises three transparent substrates 17, 18, 19 and the second portion 16 two substrates 20, 21 through which the light passes. In this context, at least some of the entry and/or exit surfaces of the substrates 17, 18, 19, 20, 21 are curved or formed as lenses in order to reproduce the active surface 3 in a suitable way in the area outside the vehicle.

There is certainly the option or using one or more mirrors with suitably formed reflective surfaces instead of one of the substrates 17, 18, 19, 20, 21 or instead of several or all substrates 17, 18, 19, 20, 21.

The first portion 15 of the projection lens 2 is designed in such a way that it forms the active surface 3 of the imaging component 1 in the aspect ratio of the active surface 3. The second portion 16 is designed in such a way that it features anamorphic properties. This can be implemented, for example, by means of differently shaped cylinder geometries on the entry and exit surface of substrates 20, 21 of the second portion 16.

The second portion 16 can therefore specifically widen light emitted by it to a greater extent in the horizontal orientation than in the vertical orientation of the light distribution. As in the first sample embodiment, this makes it possible to generate a light distribution in which the ratio of vertical orientation to horizontal orientation of the active surface 3 is 1:1 despite a ratio of, for example 4:1 of the vertical orientation to the horizontal orientation (see FIG. 3). One advantage of the second embodiment in accordance with FIG. 2 is the fact that the second substrate 21 serving as exit lens can be designed to be significantly smaller than in the case of the first embodiment in accordance with FIG. 1.

There is certainly the option that the portion serving to form the active surface 3 in the correct aspect ratio is the second portion in the orientation of the widening of the light and that the portion provided with anamorphic properties is the first portion in the orientation of the widening of the light.

### LIST OF REFERENCE SYMBOLS

1 Imaging component
2 Projection lens
3 Active surface of the imaging component
4 First pixel density
5 First light distribution
6 Second pixel density
7 Second light distribution
8 Segment of the first light distribution
9 Segment of the second light distribution
10, 11 Substrate of the projection lens
12 Exit surface of a substrate of the projection lens
13 Light distribution
14 Illustration of a point of an active surface
14a, 14b Widening of the depicted point in a horizontal orientation
15 First portion of the projection lens
16 Second portion of the projection lens
17, 18, 19 Substrate of the first portion
20, 21 Substrate of the second portion

1. An illuminating device for a vehicle comprising
an imaging component with an active surface on which matrix-like imaging elements for targeted generation of pixels of a light distribution are arranged, where expansion of the active surface is larger in a first orientation than in a second orientation vertical to the first orientation,
a projection lens from which the light emitted from the active surface during operation of the illuminating device is projected into the area outside the vehicle,
wherein the active surface is aligned in such a way that with regard to the light distribution generated in the area outside the vehicle, pixels arranged alongside each other in a vertical orientation are generated by imaging elements that are arranged alongside each other in the first orientation on the active surface.

2. The illuminating device in accordance with claim 1, wherein the active surface in the state installed in the vehicle is aligned in such a way that the first orientation is vertical.

3. The illuminating device in accordance with claim 1, wherein the imaging elements on the active surface take the form of light emitting diodes or as laser diodes, and where the imaging component is a solid state LED array.

4. The illuminating device in accordance with claim 1, wherein the imaging component takes the form of a digital micromirror device or an LCoS or LC display or the imaging component comprises a digital micromirror device or an LCoS or or LC display.

5. The illuminating device in accordance with claim 1, wherein the projection lens features a surface with a toric shape.

6. The illuminating device in accordance with claim 5, wherein the surface with a toric shape widens light emitted by it in one orientation corresponding to the light distribution outside the vehicle to a greater extent than light in one orientation corresponding to the vertical orientation of the light distribution outside the vehicle.

7. The illuminating device in accordance with claim 5, wherein the surface with a toric shape is a refractive surface.

8. The illuminating device in accordance with claim 5, wherein the surface with a toric shape is the exit surface of the projection lens.

9. The illuminating device in accordance with claim 1, wherein the protection lens comprises a first portion and a second portion, where during operation of the illuminating device the light emitted by the active surface first passes through the first portion or is reflected at the first portion and subsequently passes through the second portion or is reflected at the second portion.

10. The illuminating device in accordance with claim 1, wherein the projection lens comprises a portion which forms the active surface of the imaging component in the aspect ratio of the active surface, where this portion is the first portion.

11. The illuminating device in accordance with claim 1, wherein the projection lens comprises a portion that features anamorphic properties.

12. The illuminating device in accordance with claim 11, wherein the portion provided with anamorphic properties of the projection lens widens light emitted by it in one orientation corresponding to the light distribution outside the vehicle to a greater extent than light in one orientation corresponding to the vertical orientation of the light distribution outside the vehicle.

13. The illuminating device in accordance with claim 1, wherein the expansion of the active surface in the first orientation is more than twice as big.
